(19) United States
(12) Patent Application Publication
(10) Pub. No.: US 2016/0001824 A1
(43) Pub. Date: Jan. 7, 2016

(54) Secure It Truck Bed Partition

(71) Applicant: Diana Lee Allen, Bakersfield, CA (US)

(72) Inventor: Diana Lee Allen, Bakersfield, CA (US)

(21) Appl. No.: 14/715,529

(22) Filed: May 18, 2015

Related U.S. Application Data
(60) Provisional application No. 61/994,733, filed on May 16, 2014.

(51) Int. Cl. B62D 33/02

(52) U.S. Cl. CPC B62D 33/0207

(57) ABSTRACT

A self contained, open topped partition that installs detachably in a pickup truck bed or cargo hold of a van or SUV and securely holds a variety of items for transport comprising a rectangular partition having a fixed rubber bumper or multiple rubber stops on one end, and a pair of adjustable, spring loaded compression rods at the opposite end that are tensioned variably to fit the designated space.

### CLAIM OF PRIORITY

This patent application claims priority under 35 USC 119 (e) (1) from U.S. Provisional Patent Application Ser. No. 61/994,733 filed May 16, 2014, of common inventorship herewith entitled, “Secure It Truck Bed Partition,” which is incorporated herein by reference as though the same were set forth in its entirety.

### FIELD OF THE INVENTION

The present invention pertains to the field of vehicular accessories, and more specifically to the field of security transport partitions and containers.

### BACKGROUND OF THE INVENTION

The prior art has put forth several designs for security transport partitions and containers. Among these are:

U.S. Pat. No. 5,628,442 to Mark Wayne describes a package retaining accessory for the cargo area of vehicle including a package retaining closure that is attachable to a wall or a divider of the cargo area. The accessory is comprised of a collapsible fabric material or a rigid material. The top portion in the fabric embodiment is supported in an upright position either by a pair of extension lines or by a plurality of brackets. The brackets may be fixedly attached to the wall or may be pivotably attached so that the bracket may be moved from an extended, closure supporting position to a folded position where the closure is relaxed. A retractable, foldable top is provided with fasteners to tie it in either an open position or a closed position.

U.S. Pat. No. 5,443,586 to Lee B. Cargill describes a multi purpose cargo restraint apparatus that attaches to the top of cargo bed side rails of a pick up truck and is collapsible for stowage behind the truck driver's seat. The apparatus features five ways of restraining cargo. A collapsible cross beam assembly that spans the width of the truck cargo bed can be positioned to restrain the movement of large cargo items. Tie down eye bolts are located near the side rails to attach cargo restraining lines. Tie down bolts near the center of the cross beam assembly attach additional lines or restrain pets on a leash. A net or series of lines are suspended between two vertical posts attached beneath the cross beam assembly for restraining the fore or aft movement of small cargo items. Also included is a restraint for bicycles.

U.S. Pat. No. 5,253,913 to Pierre Metivier describes a cargo cage having a body and spacer arms which are pivotally mounted to mounting members. The mounting members are mounted to the side walls of a truck bed by mounting means which may be a friction assembly or sheet metal screws, possession proximate the front or the back of the truck bed. The cargo cage is mounted proximate the front or the back of the truck bed to form a cargo space between the cargo cage and the front wall or rear wall of the truck bed. The cargo cage is pivotally mounted to accommodate larger or smaller articles within the cargo space.

None of these prior art references describe the present invention.

### SUMMARY OF THE INVENTION

It is an object of the present invention to provide a self contained, open topped partition that installs detachably in a pickup truck bed or cargo hold of a van or SUV and securely holds a variety of items for transport.

### BRIEF DESCRIPTION OF THE DRAWINGS

FIG. 1 is an illustrative prototypical diagonal outer side view of the present invention showing a panel that is manufactured in various sizes and contains stationary rubber stops on one end and threaded adjustable rubber stops on its opposite end.

FIG. 2 is a prototypical functional diagonal inner view of the present invention installed in a truck bed, adjacent to a truck's open tailgate which becomes a functioning and opposing wall when in a closed position.

FIG. 3 is an illustrative prototypical close up view of a threaded adjustable rubber stop showing a rotatable grip for length adjustment and a rubber end that presses against the truck bed or cargo inside wall to secure the present invention in place.

FIG. 4 is a front cutaway view of the present invention for an SUV or other small storage space vehicle showing the partition and stationary rubber stops at one end and adjustable rubber stops at the opposite end.

FIG. 5 is a front cutaway view of the present invention for a full size pick-up truck showing the partition and a stationary rubber bumper at one end and adjustable rubber stops at the opposite end.

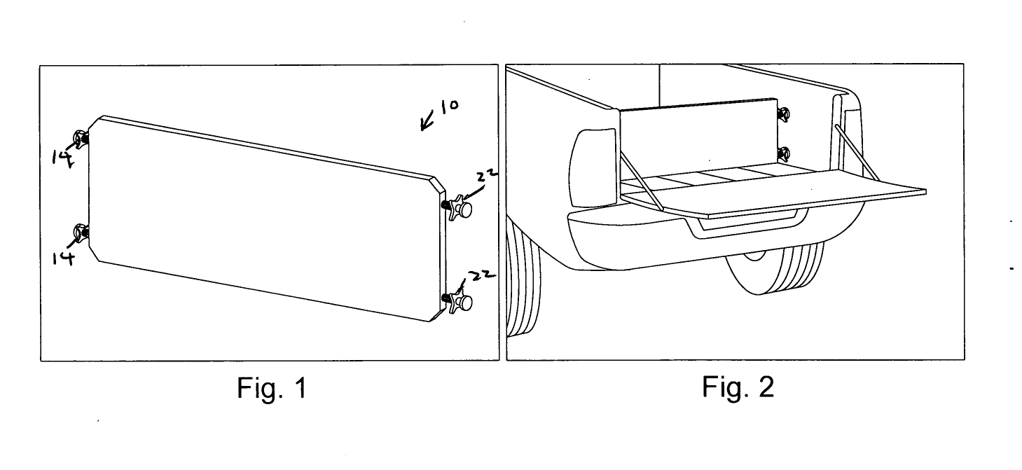

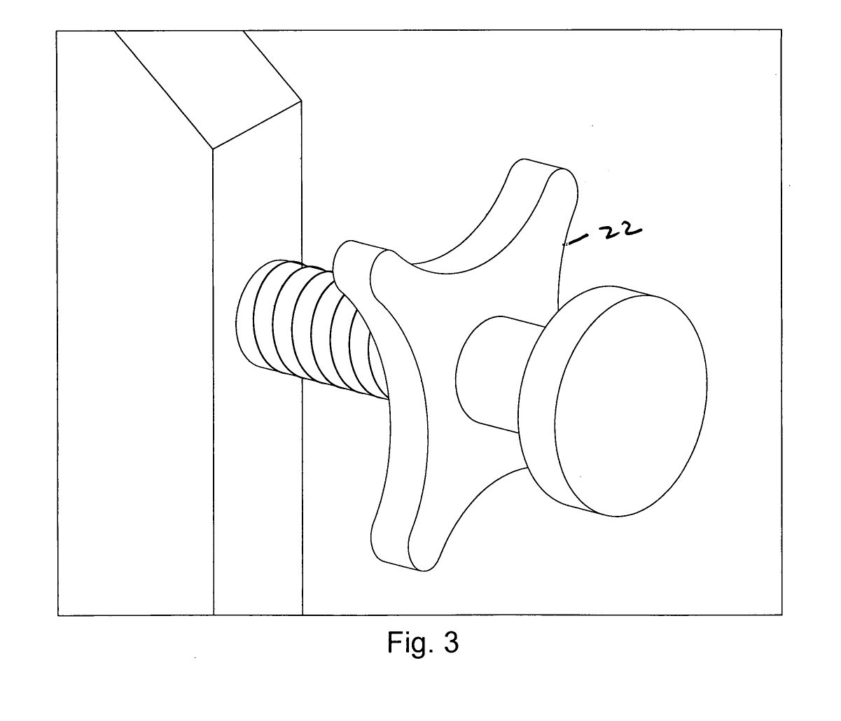

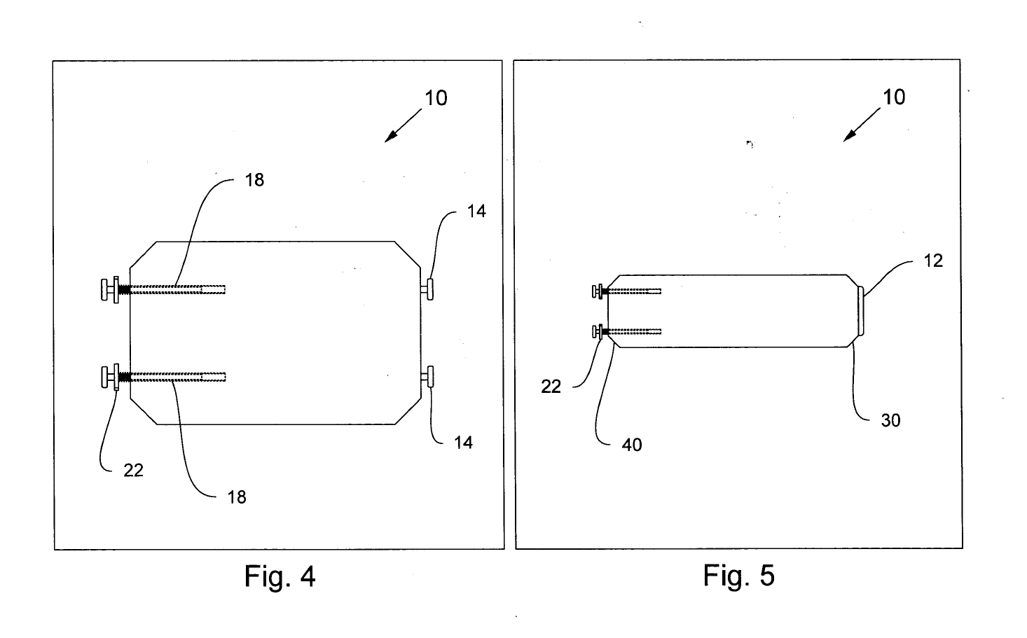

### DETAILED DESCRIPTION OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

Many people own and drive a Sports Utility Vehicle or SUV, pickup truck or van, for work, basic transportation, pleasure or recreation. All these people share a common problem. When one uses their SUV, pickup or van to carry a load of assorted loose articles from groceries to camping gear, one finds that the cargo hold or truck bed is plenty big enough to accommodate these articles. The cargo hold or truck bed is so big that articles tip over, get loose and roll all over the place.

The present invention, hereinafter referred to as Secure It Truck Bed Partition, or simply, Secure It, is a self contained, open topped partition that installs detachably in a pickup truck bed or cargo hold of a van or SUV and securely holds a variety of items for transport, from groceries to camping and boating gear. With Secure It, such articles are secured within the pickup bed or cargo hold, unable to spill out and roll around. Secure It is a lightweight storage partition or bin that fastens snugly within a truck bed or a cargo compartment in a van or SUV.

Secure It is an essentially rectangular partition fabricated in a tough and durable molded thermoplastic with open topped bin being rectangular in configuration. Secure It is produced in a variety of sizes. One size is for short bed pickups, another size is for long bed pickups, and another size is for vans and SUVs. General measurements for a midsize truck are approximately fifteen to eighteen inches in height, twenty four inches in front to back depth, and fifty six to sixty two inches in end to end length. In a full size pickup truck, the Secure It partition occupies the space between the back of the wheel wells and the tailgate, although other positions are also possible.

Please refer to the Figures. The Secure It is a rectangular partition having a first short end 30 and a second short end 40. The first short end of the Secure It 10 contains a fixed rubber bumper 12 (shown in FIG. 5) or multiple rubber stops 14. The second short end is equipped with a pair of adjustable, spring loaded compression rods 18 that are tensioned variably to fit the designated space. Compression rods 18 are adjusted by means of rubber knobs 22. The user simply pushes the first short 30 end of the partition against one side of the truck bed or cargo compartment, aligns the partition, then turns knobs 22 to adjust the spring loaded rods 18 and rubber padded compression rods to achieve a snug fit of the second short end 40 against the other side of the bed or compartment. The Secure It bin is wedged in place for stability, yet is easily detachable using the spring release buttons to free the compression rods 18.

Secure It is produced in a variety of colors. Secure It also is produced to provide alternatives such as a sectioned bin as well as an open bin or a bin with numerous cargo hooks that one partitions with bungee cords. Being lightweight, Secure It is easy to install, remove or store in a garage or shed.

Secure It partitions or bins are used interchangeably as needs arise. One keeps camping gear stored and ready in one Secure It bin, beach excursion gear in another bin, and boating gear in a third bin. In this manner, a Secure It bin serves as both a vehicular bin and a general storage bin, and one simply installs the pre packed bin required for the present purpose. Secure It bins being used as storage bins outside a vehicle include a snap locking cover for added protection security. This cover is removable when the Secure It bin is transported to a vehicle. Durably constructed and functionally exceptional, Secure It will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An open topped partition or bin that installs detachably in a pickup truck bed or cargo hold of a van or SUV and securely holds a variety of items for transport, comprising:
a rectangular partition having a first short end and a second short end, wherein the first short end contains a fixed rubber bumper or multiple rubber stops, and the second short end is equipped with a pair of adjustable, spring loaded compression rods that are tensioned variably to fit the designated space, further wherein the lengths of the compression rods are adjusted by means of rubber knobs.

2. The partition of claim 2, wherein the partition is fabricated in a tough and durable molded thermoplastic.

3. The partition of claim 1 produced in a variety of colors.

4. The partition of claim 1, wherein the partition is approximately fifteen to eighteen inches in height, twenty four inches in front to back depth, and fifty six to sixty two inches in end to end length.
